(19) United States
(12) Patent Application Publication
(10) Pub. No.: US 2024/0144148 A1
(43) Pub. Date: May 2, 2024

(54) INFORMATION PROCESSING APPARATUS, INFORMATION PROCESSING METHOD AND PROGRAM

(71) Applicant: NIPPON TELEGRAPH AND TELEPHONE CORPORATION, Tokyo (JP)

(72) Inventors: Satoshi TAKATSU, Musashino-shi, Tokyo (JP); Tomoko SHIBATA, Musashino-shi, Tokyo (JP); Hiroshi YOSHIDA, Musashino-shi, Tokyo (JP); Masanobu SAKAMOTO, Musashino-shi, Tokyo (JP)

(73) Assignee: NIPPON TELEGRAPH AND TELEPHONE CORPORATION, Tokyo (JP)

(21) Appl. No.: 18/567,774

(22) PCT Filed: Jun. 8, 2021
(86) PCT No.: PCT/JP2021/021775

§ 371 Date: Dec. 7, 2023

(51) Int. Cl. G06Q 10/0639

(52) U.S. Cl. CPC G06Q 10/06393; G06Q 10/06398

(57) ABSTRACT

Provided is a technique for facilitating evaluation of a relationship between persons in work. An information processing device according to one embodiment includes: an acquisition unit that acquires an achievement value for each work representing an achievement of each work obtained when a plurality of workers is combined and allocated to the work; a calculation unit that calculates an evaluation value for each work by comparing the achievement value for each work with a reference value; a determination unit that determines quality of a relationship between the plurality of workers based on the evaluation value for each work; and a setting unit that sets, based on a result of the determination, a relationship value numerically representing the quality of the relationship between the plurality of workers.

### TECHNICAL FIELD

One aspect of this invention relates to an information processing device, an information processing method, and a program.

### BACKGROUND ART

In human resource allocation that allocates people to work, an allocation table is often created. Due to the nature of allocating people, various items need to be considered when creating the allocation table.

In recent years, in order to support creation of an allocation table, a technique for quantification of an item such as a skill of a worker or automation of creation of an allocation table by a solver or the like using the quantification has been proposed. For example, Patent Literature 1 discloses a technique for obtaining an optimal solution that satisfies conditions including minimization of time from start to end of work, minimization of the number of people to be allocated, and minimization of dispersion of processing time for human resource allocation.

### CITATION LIST

### Patent Literature

Patent Literature 1: JP 2017-211921 A

### SUMMARY OF INVENTION

### Technical Problem

However, many items considered in creating an allocation table are difficult to quantify. In particular, the items that are difficult to quantify include a relationship between persons in a case where two or more workers are combined and allocated to work. Considering such items, it is still necessary to rely on determination of an allocator, and the allocator needs to manually create the allocation table. The manual creation of the allocation table causes problems such that time and stress are required to consider the combination, a satisfaction level of a worker decreases and dissatisfaction of the worker frequently occurs, and a performance of the worker cannot be maximized.

This invention has been made in view of the above circumstances, and an object thereof is to provide a technique that facilitates evaluation of a relationship between persons in work.

### Solution to Problem

In order to solve the above problem, one aspect of this invention is an information processing device including: an acquisition unit that acquires an achievement value for each work representing an achievement of each work obtained when a plurality of workers is combined and allocated to the work; a calculation unit that calculates an evaluation value for each work by comparing the achievement value for each work with a reference value; a determination unit that determines quality of a relationship between the plurality of workers based on the evaluation value for each work; and a setting unit that sets, based on a result of the determination, a relationship value numerically representing the quality of the relationship between the plurality of workers.

### Advantageous Effects of Invention

According to one aspect of this invention, an evaluation value for each work is calculated based on an achievement value for each work obtained when a plurality of workers is combined and allocated to the work, and quality of a relationship between the workers allocated to the work is determined based on the evaluation value for each work. Then, based on a result of the determination, a relationship value numerically representing the quality of the relationship between the workers is set. The set relationship value can be said to be a numerical value of the quality of the relationship between the workers in the work based on the achievement of each work. By using the set relationship value, a relationship between persons in work can be appropriately evaluated.

That is, according to this invention, it is possible to provide a technique that facilitates evaluation of a relationship between persons in work.

### BRIEF DESCRIPTION OF DRAWINGS

FIG. 1 is a block diagram illustrating an example of a hardware configuration of an information processing device according to an embodiment of this invention.

FIG. 2 is a block diagram illustrating a software configuration of the information processing device according to the embodiment of this invention.

FIG. 3 is a flowchart illustrating an example of information processing operation related to setting of a relationship value by the information processing device illustrated in FIG. 2.

FIG. 4 is a diagram illustrating an example of performance data associating a work allocation table and an achievement value for each work according to the embodiment of this invention.

FIG. 5 is a diagram illustrating an example of reference value data according to the embodiment of this invention.

FIG. 6 is a schematic diagram illustrating an outline of an achievement ratio according to the embodiment of this invention.

FIG. 7 is a diagram illustrating an example of achievement ratio data according to the embodiment of this invention.

FIG. 8 is a diagram illustrating an example of a determination criterion used for determining whether a relationship is good or bad according to the embodiment of this invention.

FIG. 9 is a diagram illustrating an example of a setting criterion used for setting a relationship value according to the embodiment of this invention.

FIG. 10 is a diagram illustrating a first example of matrix data representing set relationship values according to the embodiment of this invention.

FIG. 11 is a diagram illustrating a second example of matrix data representing set relationship values according to the embodiment of this invention.

FIG. 12 is a flowchart illustrating an example of information processing operation related to visualization of a worker satisfaction level by the information processing device illustrated in FIG. 2.

FIG. 13 is a diagram illustrating a visualization example of a satisfaction level according to the embodiment of this invention.

### DESCRIPTION OF EMBODIMENTS

The following is a description of embodiments according to this invention, with reference to the drawings. Note that, hereinafter, the same or similar reference signs will be given to components that are the same as or similar to those already described, and redundant description will be basically omitted.

### One Embodiment

### Configuration Example

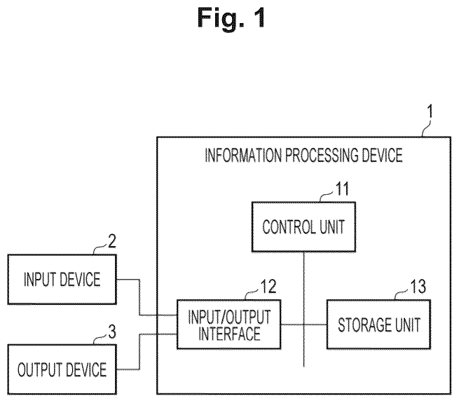

FIG. 1 is a block diagram illustrating an example of a hardware configuration of an information processing device 1 according to one embodiment.

The information processing device 1 is realized by a computer such as a personal computer (PC). The information processing device 1 includes a control unit 11, an input/output interface 12, and a storage unit 13. The control unit 11, the input/output interface 12, and the storage unit 13 are communicably connected to each other via a bus.

The control unit 11 controls the information processing device 1. The control unit 11 includes a hardware processor such as a central processing unit (CPU).

The input/output interface 12 is an interface that enables transmission and reception of information between an input device 2 and an output device 3. The input/output interface 12 may include a wired or wireless communication interface.

The storage unit 13 is a storage medium. The storage unit 13 is configured by combining a nonvolatile memory to and from which writing and reading can be performed at any time, such as a hard disk drive (HDD) or a solid state drive (SSD), a nonvolatile memory such as a read only memory (ROM), and a volatile memory such as a random access memory (RAM). The storage unit 13 includes a program storage area and a data storage area in a storage area. The program storage area stores an application program necessary for executing various processing in addition to an operating system (OS) and middleware.

The input device 2 includes, for example, a keyboard, a pointing device, and the like for a user (for example, an allocator, an administrator, a supervisor, or the like) of the information processing device 1 to input an instruction to the information processing device 1. Furthermore, the input device 2 can include a reader for reading data to be stored in the storage unit 13 from a memory medium such as a USB memory, and a disk device for reading such data from a disk medium. Further, the input device 2 may include an image scanner.

The output device 3 includes a display that displays output data to be presented from the information processing device 1 to the user, a printer that prints the output data, and the like. Furthermore, the output device 3 can include a writer for writing data to be input to another information processing device such as a PC or a smartphone to a memory medium such as a USB memory, and a disk device for writing such data to a disk medium.

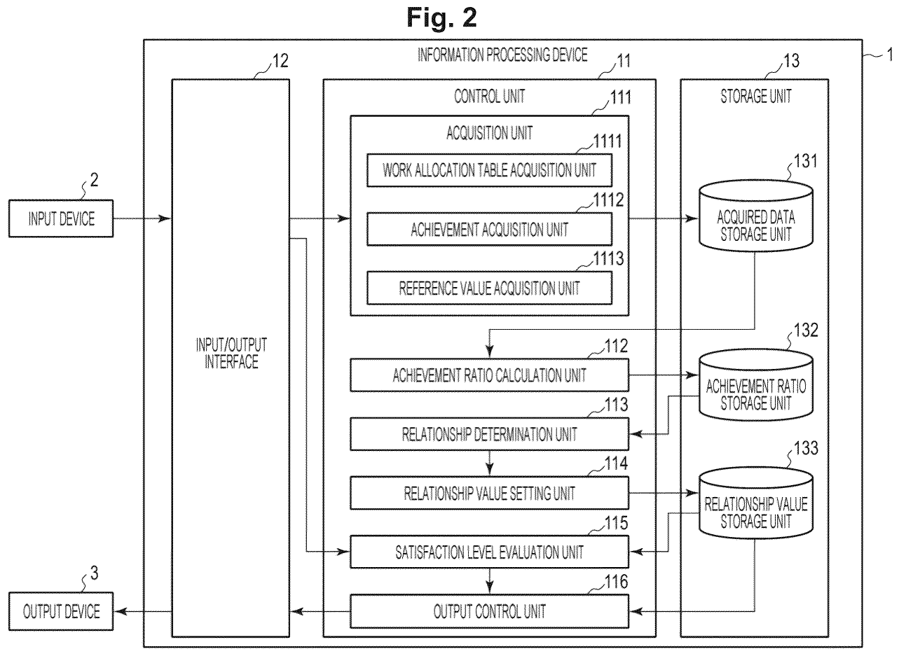

FIG. 2 is a block diagram illustrating a software configuration of the information processing device 1 in association with the hardware configuration illustrated in FIG. 1.

The storage unit 13 includes an acquired data storage unit 131, an achievement ratio storage unit 132, and a relationship value storage unit 133.

The acquired data storage unit 131 stores various data acquired by an acquisition unit 111. The data stored in the acquired data storage unit 131 includes a work allocation table, an achievement value for each work, and a reference value. Each of the work allocation table, the achievement value for each work, and the reference value may be acquired by externally capturing created data via the input device 2, or may include data generated by the control unit 11.

The achievement ratio storage unit 132 stores an achievement ratio calculated by an achievement ratio calculation unit 112. Here, the achievement ratio is used as an index of magnitude of an achievement. The achievement ratio is calculated by comparing an achievement value for each work indicating an achievement for each work with a reference value for each combination of workers. The achievement ratio is an example of an evaluation value for each work calculated by comparing the achievement value for each work with the reference value.

The relationship value storage unit 133 stores a relationship value representing quality of a relationship between workers by a numerical value. The relationship value storage unit 133 can store the set relationship value as matrix data.

The control unit 11 includes the acquisition unit 111, the achievement ratio calculation unit 112, a relationship determination unit 113, a relationship value setting unit 114, a satisfaction level evaluation unit 115, and an output control unit 116. These functional units are implemented by the hardware processor executing an application program stored in the storage unit 13.

The acquisition unit 111 acquires necessary data and stores the acquired data in the acquired data storage unit 131. The acquisition unit 111 includes a work allocation table acquisition unit 1111, an achievement acquisition unit 1112, and a reference value acquisition unit 1113.

The work allocation table acquisition unit 1111 acquires a work allocation table indicating allocation of workers to work. The work allocation table includes allocation of a combination of a plurality of workers. The work allocation table includes, for example, a work allocation table (work allocation plan) created in the past by an allocator or an allocation plan creator. The work allocation table may include simulation data. The work allocation table includes, for example, information for identifying work and information for identifying a worker allocated to the work.

The achievement acquisition unit 1112 acquires an achievement value for each work representing an achievement obtained when a worker is allocated to work in accordance with the work allocation table by a numerical value. The achievement acquisition unit 1112 is an example of an acquisition unit that acquires an achievement value for each work indicating an achievement of each work obtained when a plurality of workers is combined and allocated to the work. The achievement value for each work may be a value obtained as a result of actual work or a value obtained by simulation. The achievement value for each work is stored in association with the work allocation table.

The reference value acquisition unit 1113 acquires a reference value related to an achievement of each work. The reference value is a value serving as a reference for evaluating an achievement of work. The reference value acquisition unit 1113 can statistically calculate the reference value on the basis of the acquired achievement value for each work. Alternatively, the reference value acquisition unit 1113 may acquire the reference value as a value set in advance by an administrator or the like of the information processing device 1.

The achievement ratio calculation unit 112 reads the data stored in the acquired data storage unit 131 and calculates an achievement ratio for each combination of workers. The achievement ratio calculation unit 112 is an example of a calculation unit that calculates an evaluation value for each work by comparing the achievement value for each work with the reference value. For example, the achievement ratio calculation unit 112 calculates the achievement ratio by dividing the reference value by the achievement value for each work.

The relationship determination unit 113 determines quality of a relationship for each combination on the basis of the achievement ratio. The relationship determination unit 113 is an example of a determination unit that determines quality of a relationship between workers for each combination on the basis of the evaluation value for each work. Here, when simply referred to as “relationship”, it may be used interchangeably as “quality of relationship”. The “relationship” or “quality of relationship” may be appropriately replaced with “relation” or “state of relationship”.

The relationship value setting unit 114 sets a relationship value representing the quality of the relationship between the workers by a numerical value on the basis of a result of the determination by the relationship determination unit 113. The relationship value setting unit 114 is an example of a setting unit that sets a relationship value representing quality of a relationship between a plurality of workers by a numerical value on the basis of a result of determination. The relationship value setting unit 114 can further generate matrix data indicating the set relationship value.

The satisfaction level evaluation unit 115 evaluates a satisfaction level of each worker using the set relationship value. When a combination including an evaluation target worker (a first worker) is newly assigned to work, the satisfaction level evaluation unit 115 extracts a relationship value between the first worker and another worker included in the combination from the matrix data, and evaluates a satisfaction level of the first worker on the basis of the extracted relationship value. The satisfaction level evaluation unit 115 further has a function of visualizing the satisfaction level of the evaluation target worker. An example of the visualization is, but not limited to, generation of display data that draws a temporal change in satisfaction level.

In response to an operation of the user of the information processing device 1, the output control unit 116 outputs the relationship value or the matrix data stored in the relationship value storage unit 133 or the display data generated by the satisfaction level evaluation unit 115.

As described above, it is not easy to consider a relationship between workers when a plurality of workers is combined and assigned to work. The following two main causes are mentioned.
(i) An achievement according to a combination of workers is not mere addition (1+1=2). That is, the achievement is not necessarily “2” when a worker A who can produce an achievement “1” and a worker B who can produce an achievement “1” are combined. If a relationship between the worker A and the worker B is bad, the achievement may be less than 2. On the other hand, if the relationship between the worker A and the worker B is good, a greater achievement can be obtained than that of a worker C who can produce an achievement “2”.
(ii) An allocator can grasp only a conspicuous relationship between workers. In many cases, the allocator cannot check an actual work situation and cannot grasp whether a combination of workers is successful during the actual work. Therefore, in many cases, a combination is created on the basis of a superficial relationship. For example, a combination is created if the two seem to be good at first glance.

As described above, as a result of not sufficiently considering the relationship between the workers in creating the allocation table, there are problems that time and stress are required to consider the combination, a satisfaction level of the worker decreases and dissatisfaction of the worker frequently occurs, and a performance of the worker cannot be maximized.

The information processing device 1 according to one embodiment can easily evaluate a relationship between persons in work by quantifying the relationship. By quantifying the relationship, which is one of the items to be considered at the time of allocation, it is also easy to create an optimal combination plan by a solver or the like. As a result, it is possible to improve a work performance (safety or the like) while reducing time and effort for making a correction and time for consideration during allocation plan creation. Furthermore, since the relationship in the combination can be quantitatively evaluated, dissatisfaction of a worker can be reduced, and stress of an allocator can be reduced.

### Operation Example

Next, information processing operation performed by the information processing device 1 configured as described above will be described.

First, as a premise of the operation, it is assumed that a work allocation table in which a plurality of workers is combined and allocated to work can be acquired. In addition, it is assumed that an achievement of each work corresponding to the work allocation table is also quantitatively evaluated and can be acquired as an achievement value for each work. The achievement value may include a value related to an operating time, a required time of work, a production amount, a production speed, an amount of money (for example, a sales amount or a work cost), a satisfaction level (for example, an employee satisfaction level or a customer satisfaction level), and the like. In addition, it is assumed that which of the large and small achievement values is a good condition or a bad condition is distinguished in advance. (For example, in a case of the required time, the shorter the time, the larger the achievement, and in a case of the production amount, the larger the amount, the larger the achievement.) Then, it is assumed that the larger the achievement (or the higher the achievement), the better the personal relationship. An achievement evaluation axis is not limited to one axis, and achievements related to a plurality of evaluation axes may be integrated and used as an achievement value for each work.

Hereinafter, for convenience of description, an example in which two workers are combined and assigned to work will be described. When determining whether a relationship is good or bad, in general, accuracy is improved as the number of people included in a combination is smaller. However, the present embodiment can be applied to a combination of any number of people as long as an achievement value is appropriately obtained.

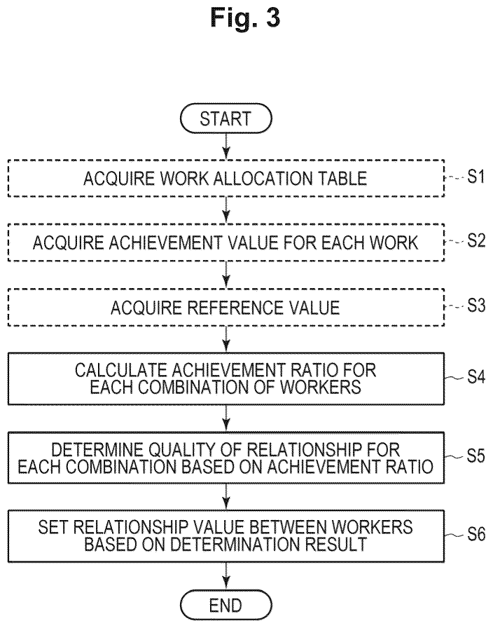

FIG. 3 is a flowchart illustrating an example of the information processing operation by the information processing device 1.

Of steps S1 to S6, steps S1 to S3 may be executed in advance as a preparation stage.

First, in step S1, the information processing device 1 causes the work allocation table acquisition unit 1111 to acquire a work allocation table. The work allocation table is, for example, a work allocation plan created by an allocator in the past, and includes allocation obtained by combining a plurality of workers.

Next, in step S2, the information processing device 1 causes the achievement acquisition unit 1112 to acquire an achievement value for each work indicating an achievement of each work obtained in a case where a plurality of workers is combined and allocated to the work in accordance with the work allocation table. As described above, the achievement value for each work is a numerical value of an achievement of each work. The achievement value for each work includes, for example, data capable of quantitatively evaluating an achievement of work, such as a time required for unit work, a cost required for the unit work, or a production amount per unit time. For example, when the work relates to repair work, the achievement value for each work may be a time required for repair, a cost required for the repair, or an achievement value obtained by integrating and evaluating these. In addition, for example, in a case where the work relates to a manufacturing operation, the achievement value for each work may be a manufacturing amount per unit time, a required time per unit product, a defective product rate, or the like, or may be an achievement value obtained by integrating and evaluating these. Alternatively, the achievement value for each work may include data obtained by quantifying a subjective evaluation such as a satisfaction level of a worker or an objective evaluation such as a customer satisfaction level. In the following description, as an example, it is assumed that the work is work related to “failure repair work for a communication line”. In this case, it is assumed that the faster the repair, the greater the achievement, and that the slower the repair, the smaller the achievement.

In one embodiment, the acquisition unit 111 stores the acquired work allocation table and the achievement value for each work in the acquired data storage unit 131 in association with each other. The work allocation table and the achievement value for each work include data related to a plurality of combinations of workers.

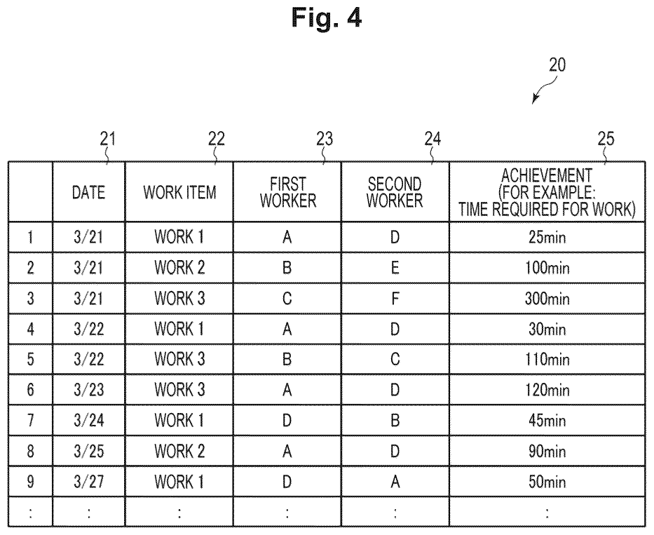

FIG. 4 illustrates an example of data which is stored in the acquired data storage unit 131 and associates the work allocation table with the achievement value for each work (hereinafter referred to as “performance data”). In particular, it is assumed that performance data 20 is an example in which only work performed by two people for one work is extracted. In the illustrated example, the performance data 20 includes, as items, a date 21, a work item 22, a first worker 23, a second worker 24, and an achievement 25.

The date 21 indicates a date on which the work is performed (or has been performed). The date 21 may further include time information.

The work item 22 includes information that can identify the work. In the illustrated example, work 1, work 2, and work 3 are illustrated as three types of work related to the failure repair work.

The first worker 23 and the second worker 24 include information capable of identifying two workers assigned to each work. The worker assigned to the work includes a worker A, a worker B, a worker C, a worker D, a worker E, and a worker F. Here, a skill of each worker or the like is not considered, and it is assumed that two workers can perform the work. In the following description, the first worker and the second worker are not distinguished from each other, and a case where the first worker is the worker A and the second worker is the worker B and a case where the first worker is the worker B and the second worker is the worker A are the same combination. However, this is merely an example, and roles may be distinguished such that the first worker is in charge of a main part and the second worker is an assistant. In this case, the case where the first worker is the worker A and the second worker is the worker B and the case where the first worker is the worker B and the second worker is the worker A can be treated as different combinations.

The achievement 25 indicates an achievement value obtained when a combination of the first worker 23 and the second worker 24 is assigned to the work designated by the work item 22. The achievement value represents time required for each work. In this example, it is assumed that, in any work, the smaller the achievement value (the shorter the time), the larger the achievement. For example, in the first row, a combination of the worker A and the worker D has been assigned to the work 1 on March 21 (3/21), and the work required 25 minutes (25 min). On the other hand, in the seventh row, a combination of the worker D and the worker B has been assigned to the work 1 on March 24 (3/24), and the work required 45 minutes (45 min). Comparing these two rows, it can be said that the combination of the worker A and the worker D has achieved a greater result than the combination of the worker D and the worker B.

The achievement value for each work may be a value based on a plurality of evaluation axes. In this case, for example, the following formula can be used as a total achievement value.

Total achievement value={(achievement value of axis 1)+(achievement value of axis 2)+ . . . +(achievement value of axis N)}/N (number of axes)

Subsequently, in step S3, the information processing device 1 causes the reference value acquisition unit 1113 to acquire a reference value. As described above, the reference value acquisition unit 1113 may acquire the reference value as a preset value, or may statistically calculate the reference value on the basis of the performance data as illustrated in FIG. 4. As an example, it is assumed that the reference value acquisition unit 1113 acquires, as a reference value, a representative value for each work calculated from an achievement value for each work acquired for a plurality of combinations of workers. Note that, in the following description, it is assumed that the reference value is a value acquired for each work by distinguishing the work, but the reference value may be a single value without distinguishing the work.

The reference value acquisition unit 1113 extracts data of the same work (for example, “work 1”) regardless of a combination of workers, and calculates a representative value. The representative value is, for example, an average value, a median value, or a mode value. In the following description, as another example, it is assumed that the reference value acquisition unit 1113 calculates an average value of achievements for each work (“average value for each work”) on the basis of the achievement value for each work obtained in step S2, and uses the average value for each work as the reference value. The reference value can also be rephrased as an average value for each work of achievements obtained by combinations of all workers. The reference value acquisition unit 1113 stores the acquired reference value as reference value data in the acquired data storage unit 131.

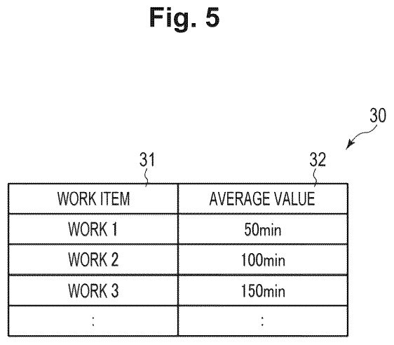

FIG. 5 illustrates an example of reference value data acquired by the reference value acquisition unit 1113 and stored in the acquired data storage unit 131. In the illustrated example, reference value data 30 includes a work item 31 and an average value 32 as items.

The work item 31 includes information capable of identifying work, similarly to the work item 22 of the performance data 20 illustrated in FIG. 4.

The average value 32 indicates an average value for each work of achievements calculated for each work item. In the illustrated example, an average value for “work 1” is “50 min”, an average value for “work 2” is “100 min”, and an average value for “work 3” is “150 min”. For example, the reference value acquisition unit 1113 extracts a record in which the work item 22 has a value of “work 1” from the performance data 20 illustrated in FIG. 4, and calculates an average value of the achievement values (the first row “25 min”, the fourth row “30 min”, the seventh row “45 min”, the ninth row “50 min” . . . ) to obtain the average value “50 min” for the work 1. Similarly, the reference value acquisition unit 1113 extracts a record in which the work item 22 has a value of “work 2” from the performance data 20, and calculates an average value of the achievement values (the second row “100 min”, the eighth row “90 min” . . . ) to obtain the average value “100 min” for the work 2. Similarly, the reference value acquisition unit 1113 extracts a record in which the work item 22 has a value of “work 3” from the performance data 20, and calculates an average value of the achievement values (the third row “300 min”, the fifth row “110 min”, the sixth row “120 min” . . . ) to obtain the average value “150 min” for the work 3. The reference value acquisition unit 1113 can repeat similar calculation for the type of work included in the performance data 20.

Subsequently, in step S4, the information processing device 1 causes the achievement ratio calculation unit 112 to calculate an achievement ratio for each work for each combination of workers. The achievement ratio calculation unit 112 extracts data related to a combination of the same workers among a plurality of combinations of workers from the performance data stored in the acquired data storage unit 131, and calculates an achievement ratio for each work. As described above, in the work related to the failure repair work, when the achievement value is the time required for the work, the repair is faster and the achievement is larger as the value is smaller. However, for example, in the manufacturing operation, when the achievement value is the number of products per unit time, the manufacturing speed is higher and the achievement is larger as the value is larger. Therefore, in one embodiment, magnitude of an achievement is expressed using an index of an achievement ratio.

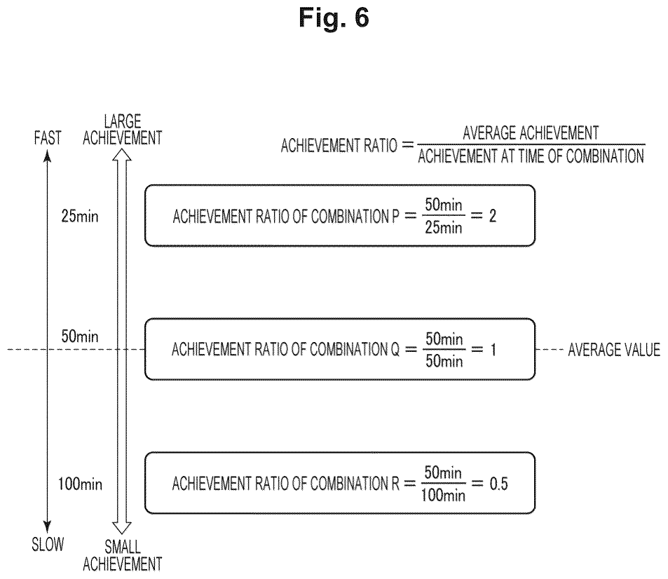

FIG. 6 is a schematic diagram illustrating an outline of an achievement ratio. For example, the achievement ratio calculation unit 112 calculates an achievement ratio by using the following Formula 1 in a case of work related to failure repair work.

Achievement ratio=(average achievement)/(achievement at the time of combination) (Formula 1)

Here, the average achievement is, for example, an average value for each work illustrated in the reference value data 30 of FIG. 5. FIG. 6 illustrates an achievement ratio related to “work 1”.

For example, it is assumed that a combination P of workers (for example, a combination of the worker A and the worker D) requires 25 minutes for the work 1. According to the reference value data 30 illustrated in FIG. 5, since the average value of the work 1 is 50 minutes, an achievement ratio of the combination P is calculated as follows.

Achievement ratio of combination P=50 min/25 min=2

Assuming that a combination Q of workers (for example, a combination of the worker B and the worker E) requires 50 minutes for the work 1, an achievement ratio of the combination Q is calculated as follows.

Achievement ratio of combination Q=50 min/50 min=1

Assuming that a combination R of workers (for example, a combination of the worker C and the worker F) requires 100 minutes for the work 1, an achievement ratio of the combination R is calculated as follows.

Achievement ratio of combination R=50 min/100 min=0.5

Here, the shorter the time required for the work, the larger the value of the achievement ratio and the larger the achievement. On the contrary, the longer the time required for the work, the smaller the value of the achievement ratio and the smaller the achievement. Since the achievement ratio of the combination P is 2, it is determined that the achievement is twice the average value (achievement is large). Since the achievement ratio of the combination Q is 1, it is determined that the achievement is an average achievement. On the other hand, since the achievement ratio of the combination R is 0.5, it is determined that the achievement is 0.5 times the average value (achievement is small).

In a case where an achievement value is the number of products per unit time or the like and an achievement is regarded larger as the achievement value is larger, the following Formula 2 in which a denominator and a numerator are interchanged is used for calculating an achievement ratio.

Achievement ratio=(achievement at the time of combination)/(average achievement) (Formula 2)

According to the Formula 2, for example, in a case where two persons can manufacture only one product per unit time and then can manufacture two products, it is considered that the achievement is doubled.

Whether to use the Formula 1 or the Formula 2 may be set in advance for each work by a user or the like.

An example in which the achievement ratio calculation unit 112 calculates an achievement ratio for a combination of the worker A and the worker D from the performance data 20 illustrated in FIG. 4 will be described. The achievement ratio calculation unit 112 first extracts a record in which the first worker 23 is “A” and the second worker 24 is “D” (the first row, the fourth row, the sixth row, the eighth row . . . ) and a record in which the first worker 23 is “D” and the second worker 24 is “A” (the ninth row . . . ) from the performance data 20. Next, the achievement ratio calculation unit 112 reads, for each record, a work reference value (an average value for each work) indicated in the work item 31 from the reference value data 30 illustrated in FIG. 5, and calculates an achievement ratio by using the above Formula 1. The achievement ratio calculation unit 112 stores the calculated achievement ratio in the achievement ratio storage unit 132 as achievement ratio data.

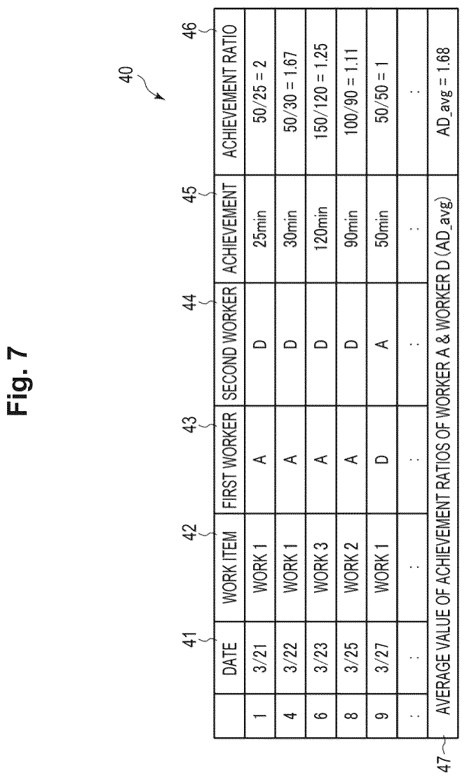

FIG. 7 illustrates an example of achievement ratio data stored in the achievement ratio storage unit 132. Achievement ratio data 40 corresponds to the above example in which the achievement ratio calculation unit 112 calculates the achievement ratio for the combination of the worker A and the worker D from the performance data 20. In the illustrated example, the achievement ratio data 40 includes, as items, a date 41, a work item 42, a first worker 43, a second worker 44, an achievement 45, and an achievement ratio 46. The date 41, the work item 42, the first worker 43, the second worker 44, and the achievement 45 are the same as the date 21, the work item 22, the first worker 23, the second worker 24, and the achievement 25 of the performance data 20, and thus, description thereof is omitted. The achievement ratio 46 indicates an achievement ratio calculated for each work. (For convenience of description, both a calculation formula and a result are illustrated in the drawing.) For example, since the first row “1” is “work 1”, an achievement ratio=50/25=2 obtained by dividing an average value “50 min” of the work 1 by an achievement value “25 min” is indicated. Since the next row “4” is also “work 1”, an achievement ratio=50/30=1.67 obtained by dividing the average value “50 min” by the achievement value “30 min” is indicated. Since the row “6” is the work 3, an achievement ratio=150/120=1.25 obtained by dividing the average value “150 min” of the work 3 by the achievement value “120 min” is indicated. Since the row “8” is the work 2, an achievement ratio=100/90=1.11 obtained by dividing the average value “100 min” of the work 2 by the achievement value “90 min” is indicated. Since the row “9” is the work 1, an achievement ratio=50/50=1 obtained by dividing the average value “50 min” by the achievement value “50 min” is indicated.

The achievement ratio data 40 can further include a comprehensive evaluation value 47. The comprehensive evaluation value 47 represents a comprehensive evaluation index of an achievement ratio for each work. As an example, the comprehensive evaluation value 47 is calculated as an average value AD_avg=1.68 of the achievement ratios according to the combination of the worker A and the worker D. The comprehensive evaluation value 47 may be another representative value, for example, a median value, a mode value, a maximum value, a minimum value, or the like.

Subsequently, in step S5, the information processing device 1 causes the relationship determination unit 113 to determine quality of a relationship for each combination on the basis of the calculated achievement ratio. In one embodiment, the relationship determination unit 113 determines whether a relationship between workers is good or bad for each combination of workers using a predetermined criterion on the basis of a representative value of an achievement ratio such as the comprehensive evaluation value 47 illustrated in FIG. 7.

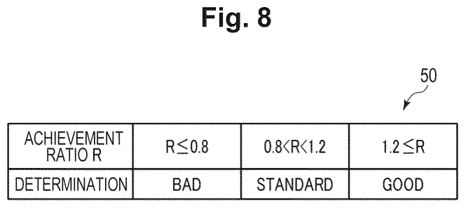

FIG. 8 is a schematic diagram illustrating an example of a determination criterion used by the relationship determination unit 113. A determination criterion 50 can be stored in a storage area (not illustrated) of the storage unit 13. In the determination criterion 50, an achievement ratio R represents a representative value of an achievement ratio such as the comprehensive evaluation value 47. According to the determination criterion 50, a combination in which the achievement ratio R is 0.8 or less (−20% or less) (R≤0.8) is determined as a relationship=BAD (a relationship is bad). According to the determination criterion 50, a combination in which the achievement ratio R is 0.8 to 1.2 (±20%) (0.8<R<1.2) is determined as a relationship=STANDARD (a relationship is normal). In addition, according to the determination criterion 50, a combination in which the achievement ratio R is 1.2 or more (+20% or more) (1.2≤R) is determined as a relationship=GOOD (a relationship is good). The determination criterion 50 is merely an example, and other criteria may be used. The relationship is not limited to the three categories of BAD/STANDARD/GOOD, and more or less categories may be used. Since AD_avg=1.68 obtained as the comprehensive evaluation value 47 in FIG. 7 corresponds to 1.2≤R, the relationship between the worker A and the worker D is determined as “GOOD”.

Next, in step S6, the information processing device 1 causes the relationship value setting unit 114 to set a relationship value numerically indicating quality of a relationship between workers on the basis of a determination result. In one embodiment, the relationship value setting unit 114 obtains a relationship value from the determination result using the following assumptions.
(J1) BAD determination: since an achievement is small, that is, a relationship is not good (bad relationship, etc.), it is assumed that only about half of a normal result can be achieved, and a relationship value is set to “0.5”.
(J2) STANDARD determination: since an achievement is standard, that is, a relationship is normal, it is assumed that an average achievement is obtained (achievement is 1+1=2, and is not 2 or more or 2 or less), and a relationship value is set to “1”.
(J3) GOOD determination: since an achievement is large, that is, a relationship is good (good relationship, etc.), it is assumed that a larger result than usual can be achieved, and a relationship value is set to “2”.

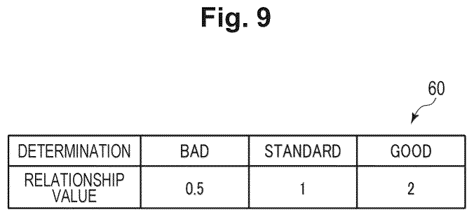

FIG. 9 is a schematic diagram illustrating an example of a setting criterion based on the above assumptions. A setting criterion 60 can be stored in a storage area (not illustrated) of the storage unit 13. According to the setting criterion 60, a relationship value is set to “0.5” in a case of the BAD determination, the relationship value is set to “1” in a case of the STANDARD determination, and the relationship value is set to “2” in a case of the GOOD determination. These values are merely examples, and other values may be used.

In the above example, since the relationship between the worker A and the worker D is determined to be “GOOD”, a relationship value between the worker A and the worker D is set to “2”. By repeating such processing for each combination of workers, it is possible to obtain relationship values between workers. The relationship value setting unit 114 stores the set relationship values in the relationship value storage unit 133. In one embodiment, the relationship value setting unit 114 generates matrix data expressing the relationship values as a matrix.

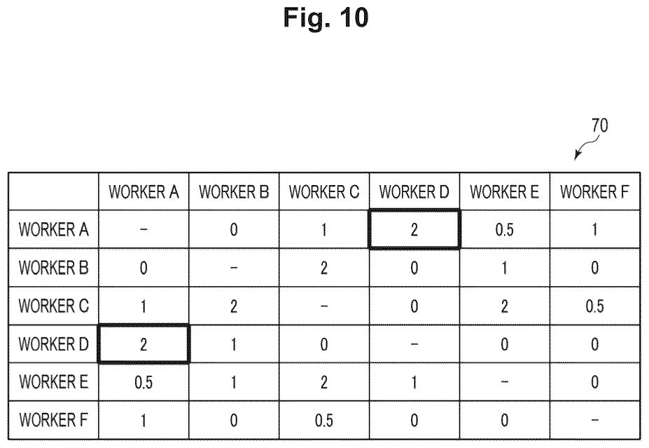

FIG. 10 illustrates an example of matrix data representing relationship values set between workers. A matrix 70 has a value “2” in fields where the worker A and the worker D intersect (two places surrounded by thick frames). According to the matrix 70, a relationship value “1” is set between the worker A and the worker C, and a relationship value “0.5” is set between the worker A and the worker E. This means that the relationship between the worker A and the worker C is normal, and the relationship between the worker A and the worker E is not good. Alternatively, it may be understood that a standard achievement is expected when the worker A and the worker C are combined and allocated to work, and a low achievement is expected when the worker A and the worker E are combined and allocated to work. Note that a value “0” in the matrix 70 indicates that a relationship value is unset (unevaluated).

For example, in response to a request from a user, the output control unit 116 can read the relationship value between the worker A and the worker D or the matrix data itself from the relationship value storage unit 133, output the read relationship value or matrix data to the output device 3, and display the read relationship value or matrix data.

As described above, the information processing device 1 can quantify the relationship between the workers on the basis of the work achievement and set the relationship as the relationship value. By using the set relationship value or matrix data, an allocator can create an optimal combination in consideration of the relationship between the workers by utilizing a tool such as a solver. For example, by further multiplying the set relationship value by other parameters such as a skill of each worker, the allocator can predict an achievement value and obtain an optimum solution that maximizes an achievement.

(Modification 1)

In the flow of FIG. 3, steps S5 and S6 may be integrated into one processing. For example, the relationship value may be directly calculated on the basis of the achievement ratio for each work obtained in step S4. As an example, the information processing device 1 may add weighting according to work to an achievement ratio for each work, and divide an addition result by the sum of weights to obtain a result as the relationship value. If this is exemplified using the achievement ratio data 40 illustrated in FIG. 7, the relationship value can be calculated as follows by values of the achievement ratio 46.

Relationship value=(2×W₁+1.67×W₁+1.25×W₃+1.11×W₂+1×W₁+ . . . )/ΣW

In the formula, W₁ represents a weighting factor of the work 1, W₂ represents a weighting factor of the work 2, W₃ represents a weighting factor of the work 3, and ΣW represents the sum of the weighting factors used ΣW=W₁+W₁+W₃+W₂+W₁+ . . . . Alternatively, a representative value of the achievement ratio such as the comprehensive evaluation value 47 may be used as it is as the relationship value.

(Modification 2)

As described above, the embodiment is also applicable to a case of using a work allocation table in which three or more workers are combined and allocated to work.

For example, in step S4, the information processing device 1 calculates an achievement ratio for each combination as described above. “Each combination” in this modification is only required to be the same combination, and may be limited to a combination of the same number of people, or may include a combination of different numbers of people. Further, as a reference value used for calculating the achievement ratio, the same reference value may be used for each work regardless of the number of workers, or different reference values may be used according to the number of workers. For example, the reference value used when calculating an achievement ratio for a combination of three workers may be an average value for each work calculated from work achievements obtained by a combination of three workers of the same number, or may be an average value for each work obtained by a combination of two workers multiplied by a predetermined coefficient.

When the achievement ratio is calculated for each combination, in step S5, the information processing device 1 can determine whether a relationship is good or bad for each combination as described above. A different determination criterion may be used depending on the number of people included in the combination, or the same determination criterion may be used regardless of the number of people.

Finally, in step S6, the information processing device 1 can set, on the basis of a determination result, a relationship value indicating, by a numerical value, whether the relationship between the workers included in the combination is good or bad. For example, as the first processing, the relationship value setting unit 114 sets a relationship value for each combination using a setting criterion similar to the one described above, and creates matrix data for each combination. Next, as the second processing, the relationship value setting unit 114 sets a relationship value between workers on the basis of the matrix data for each combination, and creates final matrix data.

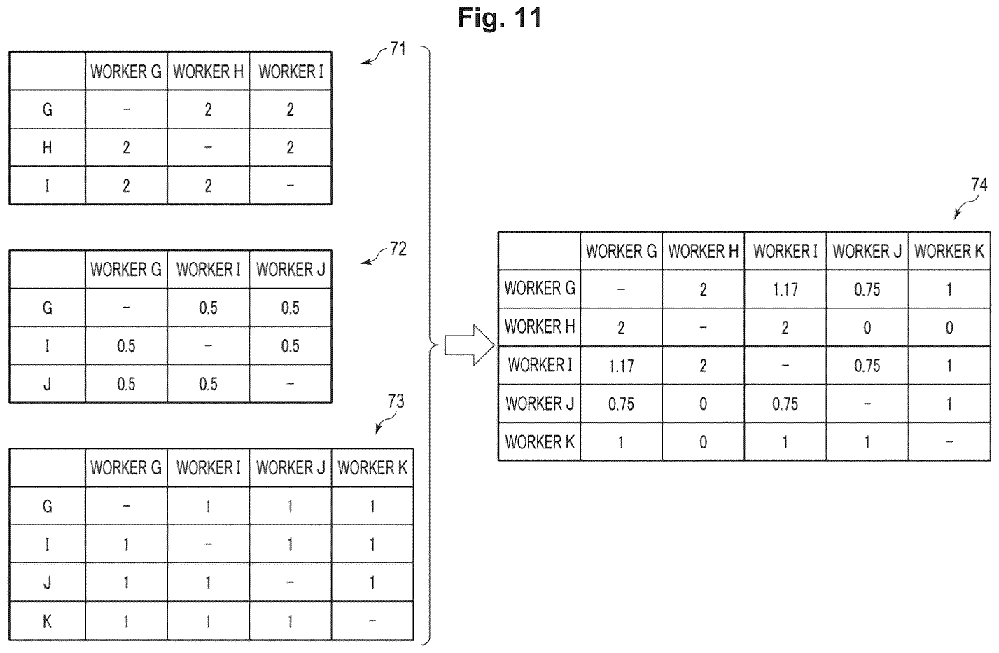

FIG. 11 illustrates an example of matrix data according to Modification 2.

In FIG. 11, a matrix 71 is an example of matrix data obtained in the above-described first processing for a combination (a worker G, a worker H, and a worker I). For this combination, it is assumed that a determination “GOOD” is obtained and a relationship value “2” is set. In the matrix 71, the value “2” is included in all fields regarding a relationship between the worker G and the worker H, a relationship between the worker H and the worker I, and a relationship between the worker I and the worker G. Similarly, a matrix 72 is an example of matrix data obtained in the first processing for a combination (the worker G, the worker I, and a worker J). Since a determination “BAD” is obtained for this combination, the matrix 72 includes the same relationship value “0.5” in all fields. A matrix 73 is an example of matrix data obtained in the first processing for a combination (the worker G, the worker I, the worker J, and a worker K). Since a determination “STANDARD” is obtained for this combination, the matrix 73 includes the same relationship value “1” in all fields.

In FIG. 11, a matrix 74 is an example of final matrix data obtained in the second processing on the basis of the matrices 71 to 73. The matrix 74 is created by taking an average value of the relationship values set in the matrices 71 to 73. For example, a relationship value between the worker G and the worker H is set only in the matrix 71 of the matrices 71 to 73. Therefore, as the relationship value between the worker G and the worker H in the matrix 74, the value “2” set in the matrix 71 is adopted as it is. A relationship value between the worker G and the worker I is set for all of the three matrices 71 to 73, and thus, for example, an average value of the three matrices is adopted in the matrix 74 as follows.

Relationship value between worker G and worker I in matrix 74=average value of {relationship value (2) in matrix 71, relationship value (0.5) in matrix 72, and relationship value (1) in matrix 73}=(2+0.5+1)/3≈1.17

Similarly, since a relationship value between the worker G and the worker J is set in the matrix 72 and the matrix 73, an average value (0.5+1)/2=0.75 is adopted. Since a relationship value between the worker G and the worker K is set only in the matrix 73, the value “1” set in the matrix 73 is adopted as it is. For example, since a relationship value between the worker H and the worker J is not set in the matrices 71 to 73, a value “0” is adopted.

### Application Example

Next, an application example using the relationship values set as described above will be described. In the application example, the information processing device 1 further visualizes a potential satisfaction level of each worker by the satisfaction level evaluation unit 115 using the set relationship values between the workers.

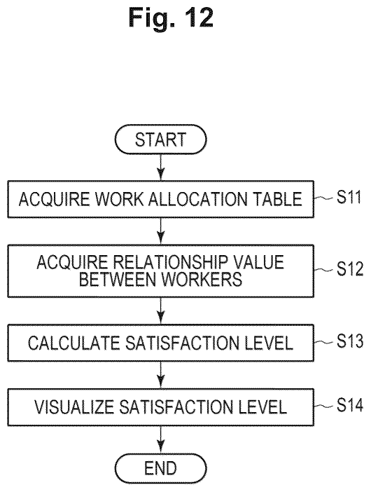

FIG. 12 is a flowchart illustrating an example of operation related to visualization of such a worker satisfaction level.

In step S11, the satisfaction level evaluation unit 115 acquires a new work allocation table via the input device 2. Here, it is assumed that the new work allocation table acquired in step S11 is a work allocation table that is not used for setting a relationship value. The acquired work allocation table may be an actually used work allocation table, a work allocation table to be used, or simulation data.

In step S12, the satisfaction level evaluation unit 115 extracts a combination of two or more persons including an evaluation target worker from the acquired work allocation table, and acquires a relationship value for the extracted combination. For example, when the evaluation target worker is the worker A and the work allocation table includes a combination of two persons (the worker A and the worker D), the satisfaction level evaluation unit 115 reads a relationship value between the worker A and the worker D from the matrix data. For example, in a case of the matrix 70 illustrated in FIG. 10, the satisfaction level evaluation unit 115 reads the relationship value “2”. Similarly, when the work allocation table includes a combination of three or more persons, the satisfaction level evaluation unit 115 can read all relationship values related to the evaluation target worker. For example, when the evaluation target is the worker A and the work allocation table includes a combination (the worker A, the worker D, and the worker E), the satisfaction level evaluation unit 115 reads out the relationship value “2” between the worker A and the worker D and the relationship value “0.5” between the worker A and the worker E from the matrix 70.

In step S13, the satisfaction level evaluation unit 115 calculates a satisfaction level based on the acquired relationship value. For example, the satisfaction level evaluation unit 115 sets the satisfaction level to 100 (start value), and changes the satisfaction level on the basis of the relationship value each time the evaluation target worker is assigned to the work. For example, when the relationship value is larger than 1 (the relationship is “good”), the satisfaction level is set to “+1”. When the relationship value is “1” (the relationship is “normal”), the satisfaction level is set to “±0”. When the relationship value is less than 1 (the relationship is “bad”), the satisfaction level is set to “−1”. When the relational value is “0” (unevaluated), the satisfaction level is set to “±0”. If the satisfaction level is calculated and updated in this manner every time allocation is performed, a temporal change in the satisfaction level can be obtained. If an allowable limit value of the satisfaction level at which a job separation rate jumps is known in advance, it is possible to reduce the number of people leaving their jobs by taking appropriate measures in a timely manner.

In step S14, the satisfaction level evaluation unit 115 performs processing of visualizing the satisfaction level. The visualizing processing includes processing of creating an image, a chart, a graph, or the like that draws a temporal change in the satisfaction level. The visualizing processing may be processing of numerically outputting the latest satisfaction level or a series of satisfaction levels. The satisfaction level evaluation unit 115 generates and outputs display data for displaying the visualized satisfaction level to a user.

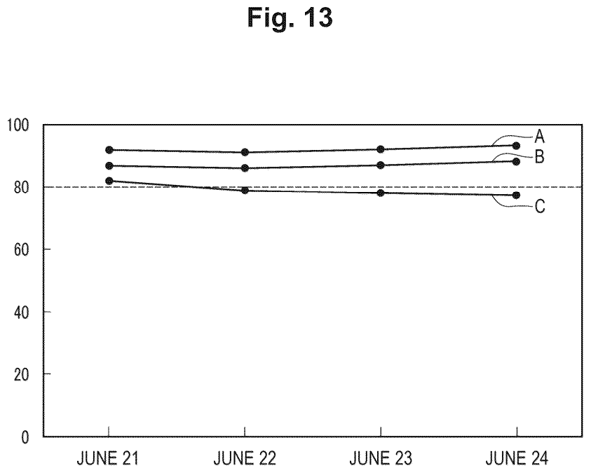

FIG. 13 illustrates an example of visualizing a satisfaction level by the satisfaction level evaluation unit 115. In this example, a temporal change of the satisfaction level is displayed by a line graph in which time is plotted on the horizontal axis and the satisfaction level is plotted on the vertical axis. A dashed line in the graph represents an allowable limit value of the satisfaction level at which a job separation rate jumps. In the illustrated example, the allowable limit value is “satisfaction level=80”. It can be seen that in an evaluation period from June 21 to June 24, the worker A and the worker B maintain relatively high satisfaction levels. On the other hand, a satisfaction level of the worker C has barely exceeded the allowable limit value on June 21, but has fallen below the allowable limit value on June 22, and has shown a decreasing trend thereafter. It is considered that the worker C needs to take individual measures such as a careful allocation or an interview.

The satisfaction level of the worker can also be evaluated by active satisfaction measurement such as a roll call or a pulse survey. For example, when a manager performs a daily roll call, a change in satisfaction level can be estimated by checking voice and expression of each worker and keeping a record. However, this method depends on subjective evaluation of the manager, and reliability of the record is not sufficiently high. In addition, there are many cases where the manager cannot grasp a worker who superficially works as usual but accumulates dissatisfaction or a shy worker who cannot express dissatisfaction. The pulse survey can conduct an attitude survey of a worker in a short span, but is not sufficient as an evaluation of a potential satisfaction level of the worker. In addition to the active satisfaction measurement such as the roll call and the pulse survey, a mechanism for grasping the potential satisfaction level of the worker is also required. The satisfaction level evaluation unit 115 can evaluate and visualize such a potential satisfaction level of the worker on the basis of the relationship value set on the basis of the work achievement. In addition, for example, if the allowable limit value of the satisfaction level at which the job separation rate jumps is known in advance as described above, an effort to reduce the number of people leaving the job can be made using a result of the visualization.

(Effects)

As described above in detail, in one embodiment of this invention, quality of a relationship between workers is determined for each combination of the workers on the basis of an achievement value of the work obtained when a plurality of workers is combined and assigned to the work, and a relationship value indicating the quality of the relationship between the workers by a numerical value is set for each combination. As a result, it is possible to quantify a relationship between persons in work and to easily evaluate the relationship.

Furthermore, according to one embodiment,
(A1) by focusing on an achievement in a case where workers are combined, it is possible to quantify a viewpoint that is difficult to quantify, such as a good relationship between people;
(A2) by quantifying a relationship between workers, the workers can be assigned to work in an optimum combination; and
(A3) by displaying the relationship between the workers in a matrix, the relationship can be easily grasped. For example, even a beginner or an allocator from another workplace can understand at a glance “unfavorable combination” or “highly successful combination” in the workplace. As a result, it is possible to shorten a consideration time required to create an allocation plan and reduce stress of the allocator during and after creation of the allocation plan. In addition, it is possible to newly consider a combination of workers that has not been considered so far since the allocator has not been able to grasp the relationship, and there is a possibility that a larger result than before can be achieved.

Further, in one embodiment, by utilizing a set relationship value, changes in a potential satisfaction level of a worker can be evaluated from combinations in a daily work. This allows potential dissatisfaction to be addressed in a timely manner and also reduces the number of people leaving the job.

By quantifying the relationship between people that has been difficult to consider in the past, an optimal solution can be easily obtained, an achievement can be maximized. Also, the satisfaction level of the worker can be improved, and performance and motivation of the worker are also expected to be improved. As a result, atmosphere in the workplace is also improved, and it is possible to further improve the results and further reduce the number of people leaving the job. Furthermore, in the future, it is also expected to lead to support for multi-skilled workers and optimization of an entire organization.

### OTHER EMBODIMENTS

Note that this invention is not limited to the above embodiment. For example, the satisfaction level evaluation unit 115 may not necessarily be provided in the information processing device 1. The processing of setting the relationship value may be executed by the information processing device 1, and the satisfaction level evaluation using the set relationship value may be executed in a device different from the information processing device 1.

The functional units included in the information processing device 1 may be dispersedly arranged in a plurality of devices, and these devices may cooperate with each other to perform processing. Each functional unit may be implemented using a circuit. The circuit may be a dedicated circuit that implements a specific function, or may be a general-purpose circuit such as a processor.

The evaluation value for each work used for determining the quality of the relationship for each combination of the workers is not limited to the achievement ratio defined by the above Formula 1 or Formula 2. Other formulas may be used to calculate the achievement ratio. The evaluation value for each work may be calculated by another statistical method such as a deviation value. The evaluation value for each work may be replaced with another index capable of quantitatively evaluating what kind of achievement can be obtained for an assigned work for each combination of workers.

Furthermore, the flow of each set of processing described above is not limited to the described procedure, and the order of some steps may be changed, or some steps may be performed simultaneously in parallel. Also, the series of processing described above does not need to be carried out continuously in terms of time, and each step may be carried out at any timing.

The method described above can be stored in a recording medium (storage medium) such as a magnetic disk (floppy (registered trademark) disk, hard disk, or the like), an optical disk (CD-ROM, DVD, MO, or the like), or a semiconductor memory (ROM, RAM, flash memory, or the like) as programs (software means) that can be executed by a computing machine (computer), and can also be distributed by being transmitted through a communication medium. Note that the programs stored on the medium side also include a setting program for configuring, in the computing machine, a software means (including not only an execution program but also tables and data structures) to be executed by the computing machine. The computing machine that implements the above device executes the above-described processing by reading the programs recorded in the recording medium, constructing the software means by the setting program as needed, and controlling the operation by the software means. Note that the recording medium described in the present specification is not limited to a recording medium for distribution, but includes a storage medium such as a magnetic disk or a semiconductor memory provided in the computing machine or in a device connected via a network.

In short, this invention is not limited to the embodiments described above, and various modifications can be made in the implementation stage without departing from the scope thereof. Also, the embodiments may be implemented in an appropriate combination, and in that case, combined effects can be obtained. Furthermore, the embodiments described above include various inventions, and various inventions can be extracted by a combination selected from a plurality of disclosed components. For example, even if some components are eliminated from all the components described in the embodiments, in a case where the problem can be solved and the advantageous effects can be obtained, a configuration from which the components are eliminated can be extracted as an invention.

### REFERENCE SIGNS LIST

1 Information processing device
2 Input device
3 Output device
11 Control unit
12 Input/output interface
13 Storage unit
111 Acquisition unit
1111 Work allocation table acquisition unit
1112 Achievement acquisition unit
1113 Reference value acquisition unit
112 Achievement ratio calculation unit
113 Relationship determination unit
114 Relationship value setting unit
115 Satisfaction level evaluation unit
116 Output control unit
131 Acquired data storage unit
132 Achievement ratio storage unit
133 Relationship value storage unit

1. An information processing device comprising:
acquisition circuitry that acquires an achievement value for each work representing an achievement of each work obtained when a plurality of workers is combined and allocated to the work;
calculation circuitry that calculates an evaluation value for each work by comparing the achievement value for each work with a reference value;
determination circuitry that determines quality of a relationship between the plurality of workers based on the evaluation value for each work; and
setting circuitry that sets, based on a result of the determination, a relationship value numerically representing the quality of the relationship between the plurality of workers.

2. The information processing device according to claim 1, wherein;
the acquisition circuitry acquires the achievement value for each work for a plurality of combinations of workers,
the calculation circuitry further calculates, based on the evaluation value for each work calculated from the achievement value for each work related to a combination of same workers among the plurality of combinations of workers, a comprehensive evaluation value for the combination of the same workers,
the determination circuitry determines quality of a relationship between the plurality of workers for each combination of the same workers based on the comprehensive evaluation value, and
the setting circuitry sets, based on a result of the determination, a relationship value numerically representing quality of a relationship between two workers included in the plurality of combinations.

3. The information processing device according to claim 1, wherein;
the setting circuitry further generates matrix data indicating the set relationship value.

4. The information processing device according to claim 3, further comprising:
satisfaction level evaluation circuitry that extracts a relationship value between a first worker and another worker in a combination of workers including the first worker from the matrix data, and evaluates a satisfaction level of the first worker based on the extracted relationship value.

5. The information processing device according to claim 4, wherein;
when the combination of workers including the first worker is allocated to work, the satisfaction level evaluation circuitry further evaluates the satisfaction level of the first worker in the combination, and generates display data indicating a temporal change in the satisfaction level of the first worker.

6. The information processing device according to claim 1, wherein:
the reference value is a representative value for each work calculated from the achievement value for each work acquired for the plurality of combinations of workers.

7. An information processing method, comprising:
acquiring an achievement value for each work representing an achievement of each work obtained when a plurality of workers is combined and allocated to the work;
calculating an evaluation value for each work by comparing the achievement value for each work with a reference value;
determining quality of a relationship between the plurality of workers based on the evaluation value for each work; and
setting a relationship value numerically representing the quality of the relationship between the plurality of workers based on a result of the determination.

8. A non-transitory computer readable storage medium storing program for causing a computer to execute processing by each of the circuitries of the information processing device according to claim 1.

9. A non-transitory computer readable storage medium storing program for causing a computer to execute the method of claim 7.
